(19) United States
(12) Patent Application Publication
(10) Pub. No.: US 2016/0326035 A1
(43) Pub. Date: Nov. 10, 2016

(54) METHOD FOR DECONTAMINATING CONTAMINATED WATER AND PLASTICS CONTAINER THEREFOR

(71) Applicant: Reinhard HEUSER, Linkenheim-Hochstetten (DE)

(72) Inventor: Reinhard HEUSER, Linkenheim-Hochstetten (DE)

(21) Appl. No.: 14/917,339

(22) PCT Filed: Sep. 9, 2013
(86) PCT No.: PCT/EP2013/068600

§ 371 Date: Jul. 21, 2016

(51) Int. Cl. C02F 3/34; E02B 15/04; B63B 35/32; C02F 1/40; C02F 1/68

(52) U.S. Cl. CPC C02F 3/344; C02F 1/40; C02F 1/682; B63B 35/32; E02B 15/046; E02B 15/045; C02F 2101/32

(57) ABSTRACT

The invention relates to a method for decontaminating a contaminated body of water, wherein the contaminated water is pumped out and further processed. After being pumped out, the contaminated water is mixed with a liquid decontaminating agent and then filled into a preferably floating plastic container located in the body of water, wherein the plastic container then stays in the body of water. The invention also relates to a plastic container for this.

### BACKGROUND OF THE INVENTION

1. Field of Invention

The present invention relates to a method for decontaminating a contaminated body of water, wherein contaminated water (16) is pumped off and further processed. In addition, the subject of the invention is a plastic container to be used in a method for decontaminating a contaminated body of water.

2. Brief Description of Related Art

Bodies of water are becoming ever more frequently contaminated, especially by oil pollution, and for very varied reasons. The reasons can be leaking tanks, broken oil lines, ship accidents and spills at oil production platforms. Such accidents can occur both on inland waters and on the open seas. Since oil has a lower specific weight than water, at least at the outset it floats on the water surface and makes landfall or is beached somewhere. The natural decomposition process of oil is of very long duration, and after shipping accidents, the spill is so large that it cannot be contained and eliminated without specialized measures. This is feasible with the current technical options when oil spills are small, but larger oil spills are barely able to be managed, and most end in a natural catastrophe.

Depending on the severity of oil pollution, various methods are used. For example, for smaller oil spills and pollution, binding agents are used, wherein the oil-binder mixture is pumped out, possibly placed in intermediate storage and then needing to be disposed of at great expense. If this is not possible, then this mixture sinks down to the bottom of the body of water and remains there as contaminated waste. The damage arising thereby to nature and in the body of water are difficult to grasp.

For smaller spills, it is also known to remove the oil-water mixture by suction, and then dispose of it.

### SUMMARY OF THE INVENTION

It is the object of the invention to create a method for decontaminating a contaminated body of water, in which even large-area spills in bodies of water can be quickly and effectively decontaminated at a reasonable cost.

This object is attained according to the invention, in that, after being pumped out, the contaminated water is mixed with a decontaminating agent, especially a liquid one, and then is filled into a preferably floating plastic container situated in the body of water, with the plastic container then remaining in the body of water.

With this, transport of the contaminated water in storage tanks to a subsequent external decontamination is obviated. Since no additional disposal costs arise, the invention-specific method substantially lowers the overall costs for decontamination.

With the invention-specific method, in a preferred embodiment, provision is made that the contaminated water is pumped out from the surface of the body of water. This means that the method is preferably used for spills when the contaminant floats on the body of water, as the case for example when bodies of water are oil-contaminated. The method can be especially used for large-area decontamination of contaminated water surfaces, for example to prevent so-called oil catastrophes. Preferably a large-area suction intake is used with the pumping out.

Preferably the contaminated water is pumped through a device into a plastic container configured as a flexible foil tank, which floats in the body of water. Due to complete pressure equalization between the contaminated water in the foil tank and the water outside the foil tank, the foil can be configured to be very thin, i.e. foil-like, since in essence it does not need to withstand any pressure. Virtually any volume can be selected for the foil tank, and it is limited only by the manufacturing process and the handling of the foil tank.

With the invention-specific method, preferably plastic containers are used which are closable. Through a closable opening of the foil tank, the foil tank is first filled and then closed by a closure device. In this closed foil tank, the liquid decontaminating agent acts with the contaminated water, and decontamination takes place. Closure also prevents the contaminated water from mixing with clean water after the filling.

In one advantageous embodiment of the plastic container, prior to filling, it has no inner volume. Thus, it is in particular folded, laid or rolled together, and unfolds when being filled. This prevents the impossibility of fully filling the plastic container due to air found in the plastic container.

Additionally, provision is made that the decontaminating agent does the mixing on a ship floating in the contaminated body of water in a device provided for this, or on the shore of the contaminated body of water in a device provided for this. The device removes the contaminated water from the water surface by suction via a pump, mixes it with the liquid decontaminating agent, and then pumps the mixture into the plastic container floating in the body of water. This means that the invention-specific method can be used for inland waters and on the seas.

With the invention-specific method, advantageously it is further provided that the decontaminating agent comprises a tenside, wherein microorganisms (microbes) are added to the tenside in particular. Such a decontaminating agent can be produced to target various contaminations for decontamination under varied environmental influences, such as heat or cold, fresh water or sea water, etc. Suitable selection of microorganisms can provide effective support to the decontamination. In advantageous fashion, the decontaminating agent is already contained in the tank before the tank is filled with contaminated water.

Tensides possess a property of generating very low surface tension. For example, in a mixture of oil- and grease-containing substances with water, the tenside acts as an emulsifier and thus leads to a very finely-dispersed oil-water emulsion, which offers a large working surface preparatory to the decontamination. In addition, tensides are biodegradable. For example, the liquid decontaminating agent of the invention-specific method comprises a mixture of various tensides, which are manufactured, for example, from hemp oil and yeast. The result is that this tenside mixture biodegrades especially well, and rapidly, since the microorganisms that provide for the degradation, break down this natural tenside mixture with the oil or grease-containing substances more quickly than a chemically produced tenside.

For example, in individual cases through an analysis of the contaminating oil, an oil spill can be responded to by selecting especially suitable microorganisms for the special purpose. For example, the University of Greifswald Institute for Microbiology maintains a collection of microorganisms, especially with various oil-decomposing microorganisms, wherein effective appropriate microorganisms can be chosen for various applications.

Complete decontamination can occur with this within about 30 days, and happens automatically through the decomposition process of the emulsion in the plastic container. The duration of the decomposition process depends on temperature. If all of the oil is decomposed, the microorganisms die off.

In one preferred embodiment, a material of the plastic container is biodegradable in water.

The material of the plastic container is chosen so that it decomposes only after the decomposition time of the contaminated material has passed (about 30 days in oil-contaminated water), thus after the decontamination process in the plastic container has ended. The plastic container is manufactured from materials suitable for biodegradation, and can have, for example, cellulose ester, polyhydroxyalkanoate (PHA), polycaprolactone (PCL), polybutylene adipate-terephthalate (PBAT) and/or polybutylene succinate (PSB). Due to the decomposition of the plastic container, the decontaminated water is automatically returned to the natural cycle again, without human intervention. Thus the invention-specific method is especially effective and especially environmentally friendly.

If the plastic container is not biodegradable, the invention-specific method can nonetheless be used. All that needs to be done is after the decomposition of the pollution, the plastic container is manually opened, by for example, slitting it open.

Further features and advantages of the present invention are explained in greater detail in what follows using the figures. With this, the features indicated can be the subject of the invention, either individually or in any combinations that also deviate from the combination described and depicted.

### BRIEF DESCRIPTION OF THE DRAWING

Shown in the drawings are:

FIG. 1: a depiction of the sequence for the invention-specific method on a floating ship

FIG. 2: a depiction of the sequence for the invention-specific method on the shore of a contaminated body of water.

### DETAILED DESCRIPTION OF THE INVENTION

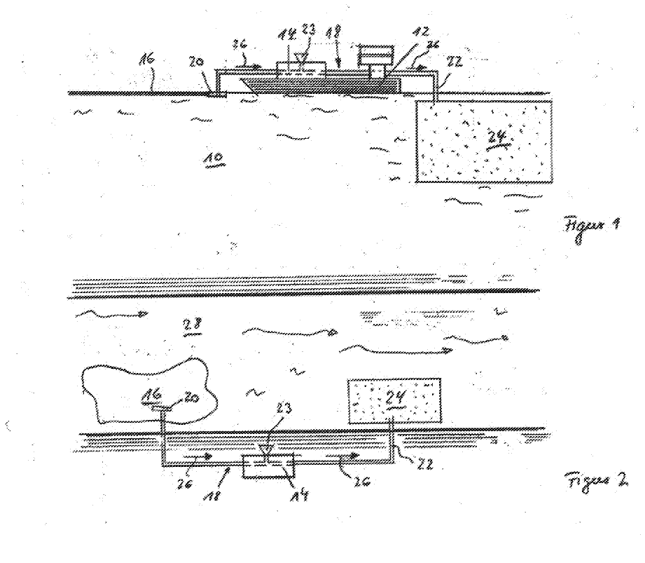

FIG. 1 shows a ship 12 floating on a sea 10, with the ship 12 bearing a device 14 for decontamination of contaminated water 16. The contaminated water 16 floats on the water, as is the case for example with oil-contaminated sea water after an oil spill. However, the ship 12 can be navigating on any polluted body of water.

Onto the device 14 a pipe system 18 is attached, which on the one side has a suction intake 20 floating on the sea 10 for taking in contaminated water 16 by suction, and on the other side has a feed line 22 which pumps the contaminated water 16 with a liquid decontaminating agent 23 into a plastic container 24 floating in the sea 10. The flow direction of the contaminated water 16 in the pipe system 18 is indicated by the reference symbol 26. Preferably the suction intake 20 is designed to cover a large area.

The plastic container 24 preferably is configured as a flexible foil tank, similar to a plastic bag. Due to the complete pressure equalization between the contaminated water 16 in the foil tank 24 and the water outside the foil tank 24, the foil can be configured to be very thin, because in essence it does not need to withstand any pressure. Due to the low weight of the foil tank 24, the filled foil tank 24 floats or hovers on the water. Preferably, before being filled, the foil tank 24 has no inner volume, and in particular is folded, laid or rolled together. It unfolds as it is filled. By this means, air that is found in the foil tank 24 is prevented from making it difficult or impossible to fully fill the foil tank 24. After being filled, the foil tank 24 remains in the sea 10.

After a large-area decontamination, the ship 12 leaves the area with contaminated water 16 and continuously removes by suction the contaminated water 16, aided by the suction intake 20 via the pipe system 18, into device 14, in which the liquid decontaminating agent 23 is mixed into the contaminated water 16. Then the mixture is pumped through a closable opening into the floating flexible foil tank 24. If the flexible foil tank 24 has been completely filled, it is closed via a closure device provided at the opening. Virtually any volume can be selected for the foil tank 24, and it is limited only by the manufacturing process and the handling of the foil tank 24.

If, owing to the large quantity of contaminated water 16, multiple flexible foil tanks 24 are required, then these can be provided during the sea voyage. Regardless of how many flexible foil tanks 24 are needed, the foil tanks 24 remain in the sea 10. In manufacturing the foil tanks 24, it is possible that biodegradable plastic is used. Thus, for example, the plastic may be composed of cellulose ester, polyhydroxyalkanoate (PHA), polycaprolactone (PCL), polybutylene adipate-terephthalate (PBAT) and/or polybutylene succinate (PSB). The material of the foil tank 24 is chosen so that it decomposes only after the decomposition period of the contaminated material has passed (about 30 days in oil-contaminated water), thus after the decontamination process in the foil tank 24 has ended.

The liquid decontaminating agent 23 in essence comprises a tenside or a tenside mixture of different tensides, which was mixed with microorganisms (microbes). Such a decontaminating agent 23 can be produced to target various contaminations for decontamination under varied environmental influences, such as heat or cold, fresh water or sea water, etc. Suitable selection of microorganisms can provide effective support to the decontamination.

FIG. 2 shows a device 14 for decontamination of contaminated water 16, which is set up on the shore of a river or of any inland body of water 28. Preferably, the device 14 is arranged to be mobile for this, i.e. on a vehicle. The contaminated water 16 floats on the surface, as is the case for example with oil-contaminated water after an oil spill. The contaminated water floating, for example, on the body of water 28 is brought out by suction via the suction intake 20 and further treated in accord with the method described above.

Here also, the contaminated water 16 mixed with the liquid decontamination agent 23 is then pumped into the flexible foil tank 24. The foil tank 24 then remains in the inland body of water 28, with the contamination in the foil tank 24 being decomposed within a certain time span. Thereafter the foil tank 24 can also decompose, or it is manually opened. By this means, the decontaminated water is automatically returned to the natural cycle again, without human intervention.

If, for example, pollution floats on a river, then a special suction intake 20 can for example be provided, which can be deployed out in its length until it can bring in contaminated water 16 by suction over the entire width of the river, as much as possible (not shown). For this, the device 14 must be set up upstream to the start of the contamination. Otherwise, the method described above is carried out.

### The Scope of the Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

1. A method for decontamination of a contaminated body of water (10; 28), wherein contaminated water (16) is pumped off and further processed, characterized in that the contaminated water (16) after pumping off is mixed with a liquid decontaminating agent (23) and then filled into a plastic container (24), including where the plastic container (24) is floating in a contaminated body of water (10; 28), with the plastic container (24) then remaining in the contaminated body of water (10; 28), and with the material of the plastic container (24) being biodegradable in the contaminated body of water (10; 28).

2. The method of claim 1, characterized in that the material of plastic container (24) is chosen so that it decomposes only after a decomposition period of the contaminated water (16) has elapsed.

3. The method of claim 1, characterized in that the contaminated water (16) is pumped off the surface of the contaminated body of water (10; 28).

4. The method of claim 1, characterized in that the liquid decontaminating agent (23) is mixed on a ship (12) floating on the contaminated body of water (10) in a device (14) provided for this or on the shore of the contaminated body of water (28) in the device (14) provided for this.

5. The method of claim 1, characterized in that the decontaminating agent (23) comprises a tenside, especially with microorganisms added to the tenside.

6. The method claim 1, characterized in that the plastic container (24) is closed after filling.

7. The method of claim 1, characterized in that the plastic container (24) is a flexible foil tank.

The method of claim 7, characterized in that the plastic container (24) is closable.

9. Then method of claim 7, characterized in that before being filled, the plastic container (24) has no inner volume and is either folded, laid or rolled together, and unfolds upon being filled.

10. The method of claim 1, characterized in that the material of the plastic container (24) comprises cellulose ester, polyhydroxyalkanoate (PHA), polycaprolactone (PCL), polybutylene adipate-terephthalate (PBAT) and/or polybutylene succinate (PSB).

11. The method of claim 2, characterized in that the contaminated water (16) is pumped off the surface of the contaminated body of water (10; 28).

12. The method of claim 2, characterized in that the liquid decontaminating agent (23) is mixed on a ship (12) floating on the contaminated body of water (10) in a device (14) provided for this or on the shore of the contaminated body of water (28) in the device (14) provided for this.

13. The method of claim 2, characterized in that the decontaminating agent (23) comprises a tenside, especially with microorganisms added to the tenside.

14. The method claim 2, characterized in that the plastic container (24) is closed after filling.

15. The method of claim 2, characterized in that the plastic container (24) is a flexible foil tank.

16. The method of claim 15, characterized in that the plastic container (24) is closable.

17. The method of claim 15, characterized in that before being filled, the plastic container (24) has no inner volume and is either folded, laid or rolled together, and unfolds upon being filled.

18. The method of claim 2, characterized in that the material of the plastic container (24) comprises cellulose ester, polyhydroxyalkanoate (PHA), polycaprolactone (PCL), polybutylene adipate-terephthalate (PBAT) and/or polybutylene succinate (PSB).

19. The method of claim 3, characterized in that the liquid decontaminating agent (23) is mixed on a ship (12) floating on the contaminated body of water (10) in a device (14) provided for this or on the shore of the contaminated body of water (28) in the device (14) provided for this.

20. The method of claim 3, characterized in that the decontaminating agent (23) comprises a tenside, especially with microorganisms added to the tenside.
